(19) United States
(12) Patent Application Publication
(10) Pub. No.: US 2026/0199945 A1
(43) Pub. Date: Jul. 16, 2026

(54) CATALYTIC THERMAL DESORPTION REMEDIATION DEVICE AND METHOD FOR ORGANICALLY CONTAMINATED SOIL

(71) Applicants: Shanghai Institute of Chemical Industry Environmental Engineering Co., Ltd, Shanghai (CN); Shanghai Research Institute of Chemical Industry CO., LTD., Shanghai (CN)

(72) Inventors: Jintao Yu, Shanghai (CN); Changbo Zhang, Shanghai (CN); xiaoyu Ma, Shanghai (CN); Xiaoyong Tang, Shanghai (CN); Yuning Xuan, Shanghai (CN); Shubo Tan, Shanghai (CN); Guilan Yang, Shanghai (CN); Yimei Zhang, Shanghai (CN)

(21) Appl. No.: 19/240,101

(22) Filed: Jun. 25, 2025

(30) Foreign Application Priority Data
Jan. 15, 2025 (CN) 2025100643945

(51) Int. Cl. B09C 1/06

(52) U.S. Cl. CPC B09C 1/06

(57) ABSTRACT

A catalytic thermal desorption remediation device and method for organically contaminated soil are provide. The device includes a thermal desorption cylinder rotatably disposed, a metal mesh annularly disposed inside the thermal desorption cylinder define a reaction chamber, a heating structure disposed on an inner wall of the thermal desorption cylinder, and catalyst filled between the heating structure and the metal mesh. The reaction chamber is configured to contain the organically contaminated soil, and a filling rate of the catalyst is 75% to 95%. The method includes: starting the heating structure, and controlling a temperature of the heating structure to a reaction temperature; loading the organically contaminated soil into the reaction chamber, and then sealing the reaction chamber; and alternately rotating the thermal desorption cylinder in forward and reverse directions to promote reaction to remove organic pollutants from the organically contaminated soil to thereby obtain processed soil.

### CROSS-REFERENCE TO RELATED APPLICATION

This application claims priority to Chinese Patent Application No. 202510064394.5, filed Jan. 15, 2025, which is herein incorporated by reference in its entirety.

### TECHNICAL FIELD

The disclosure relates to the field of soil treatment technologies, and more particularly to a catalytic thermal desorption remediation device and method for organically contaminated soil.

### BACKGROUND

Thermal desorption technology is one of the most advanced pollution waste treatment technologies in the world, and has a good degradation effect on pesticide-contaminated soil, oil-containing waste in oil fields, tank bottom sludge and so on. In domestic engineering application cases in related art, a heat treatment equipment for thermal desorption is usually rotary kiln, spiral propulsion pyrolysis furnace and other devices. Application of these devices is mature, but has many problems such as high energy consumption, large engineering volume and carbonization of soil organic matter after remediation, hindering a further development of the thermal desorption technology. Therefore, reducing energy consumption and a reaction temperature during a thermal desorption process will become a key link to break through a technical bottleneck.

In a chemical industry, catalyst is commonly added to reduce the reaction temperature. However, in the chemical industry, the catalyst is generally added directly to material, and after a reaction is completed, the catalyst and the material are separated. When the method is applied to a field of soil remediation, catalyst recovery becomes one of technical difficulties. During a process of catalyzing thermal desorption, with continuous occurrence of heat transfer loss, maintaining an activation temperature of the catalyst will also become a technical problem that cannot be ignored. With clay soil continuously wrapping the catalyst during the thermal desorption process, efficiency of the catalyst will continue to decrease, and maintaining activity of the catalyst will also limit engineering application of the method.

A Chinese patent application No. CN202010029407.2 (corresponding to patent publication No. CN111072101A) involves a heterogeneous catalytic reactor, including a raw water chamber; in which at least one purification reaction chamber is connected to a lower part of the raw water chamber, a water purification chamber is disposed below the purification reaction chamber, and a water channel is disposed between a bottom of the purification reaction chamber and a bottom of the water purification chamber. The purification reaction chamber is a vertical cylindrical body; a catalyst layer is disposed inside the purification reaction chamber; the catalyst is a photocatalyst or an electrocatalyst; and a light generating device, an electric generating device, an ultrasonic generating device or a heating device is disposed inside or outside the purification reaction chamber. In the Chinese patent application No. CN202010029407.2, a perforated water-passing plate is disposed in a filter layer to filter raw water; a closed air chamber is defined between the perforated water-passing plate and a liquid surface of the purification reaction chamber; water flows down along an inner wall of the purification reaction chamber to form a water curtain; and the light generating device generates an ultraviolet light to irradiate catalyst coating through the water curtain to initiate a catalytic reaction, thereby achieving disinfection of water. The heterogeneous catalytic reactor can be used for fluid catalysis, but cannot meet an application of remediation engineering for solid soil.

A Chinese patent application No. CN202310321759.9 (corresponding to patent publication No. CN116492938A) discloses a reactor and its application. The reactor includes a metal housing, including a first surface and a second surface disposed opposite to each other; and a metal tube bundle disposed inside the metal housing. The metal tube bundle includes metal tubes disposed in parallel. Two ends of each metal tube are respectively connected to the first surface and the second surface. The metal housing includes a material inlet and a material outlet. A shell side is defined between the metal housing and outer walls of the metal tubes, and tube sides are defined inside inner chambers of the metal tubes. The shell side is filled with granular first catalyst, and/or the tube sides are filled with granular and/or honeycomb second catalyst. Multiple metal fins are disposed on the outer walls of the metal tubes; and the multiple metal fins divide the shell side into multiple intervals connected with each other. A first material is output from the material outlet after reacting in the multiple intervals; and/or a second material undergoes a reaction in the tube sides. During an operation process of the reactor, the material inside the metal tube bundle in the shell side flows along a direction perpendicular to a length direction of each metal tube. The reactor has high structural compactness, good heat and mass transfer performance and low cost. However, in the field of soil remediation, the reactor cannot automatically load soil into and discharge the soil from the metal tube bundle, and the metal tube bundle is dense and has many dead corners, which cannot meet an engineering application of soil remediation.

### SUMMARY

The disclosure aims to provide a catalytic desorption remediation device and method for organically contaminated soil to ensure a recovery rate, activity, use condition and practical engineering application effect of a catalyst in a process of soil thermal desorption.

Objectives of the disclosure are realized through the following technical solutions.

A catalytic thermal desorption remediation device for organically contaminated soil provided by an embodiment of the disclosure includes: a thermal desorption cylinder, a heating structure and catalyst.

The thermal desorption cylinder is rotatably disposed, a metal mesh is annularly disposed inside the thermal desorption cylinder to define a reaction chamber, and the reaction chamber is configured to contain the organically contaminated soil. The heating structure is disposed on an inner wall of the thermal desorption cylinder. The catalyst is filled between the heating structure and the metal mesh, and a stacking volume of the catalyst is in a range of 75% to 95% of a volume between the heating structure and the metal mesh.

In an embodiment, a vent hole is defined on the reaction chamber.

In an embodiment, process ports are thoroughly defined on a sidewall of the thermal desorption cylinder and the heating structure, and the process ports are configured to load the catalyst.

In an embodiment, catalyst gates are disposed at the process ports, and the catalyst gates are configured to close or open the process ports.

In an embodiment, a soil inlet is thoroughly defined on the sidewall of the thermal desorption cylinder and the heating structure, and the soil inlet is configured to load the organically contaminated soil into the reaction chamber.

In an embodiment, an inlet gate is disposed on the soil inlet.

In an embodiment, the metal mesh is disposed inside the thermal desorption cylinder in a cylindrical shape.

In an embodiment, a radial section of the metal mesh is in a ratchet shape.

In an embodiment, the catalytic thermal desorption remediation device for the organically contaminated soil includes a rotating motor configured to drive the thermal desorption cylinder to rotate.

In an embodiment, the catalytic thermal desorption remediation device for the organically contaminated soil includes a bracket, a bearing disposed on the bracket and an exhaust pipe disposed on the bracket;
the thermal desorption cylinder is rotatably disposed on the bracket through the bearing; and
the vent hole is defined at a rotation center of an end surface of the thermal desorption cylinder, and the exhaust pipe extends to the vent hole and is rotatably sealed to the vent hole.

A catalytic thermal desorption remediation method for the organically contaminated soil provided by another embodiment of the disclosure includes the following steps:
S1, starting the heating structure, and controlling a temperature of the heating structure to a reaction temperature;
S2, loading the organically contaminated soil into the reaction chamber, and then sealing the reaction chamber; and
S3, alternately rotating the thermal desorption cylinder in forward and reverse directions to promote reaction to remove organic pollutants from the organically contaminated soil to thereby obtain processed soil.

Compared with related art, the disclosure has the following beneficial effects.

(1) In the disclosure, the heating structure is disposed on the inner wall the thermal desorption cylinder, and the catalyst is filled between an inner wall of the heating structure and the reaction chamber containing the organically contaminated soil. In this way, an optimal use temperature of the catalyst is ensured and catalytic efficiency is improved.

(2) In the disclosure, since the catalyst is not filled completely during use, friction and collision will occur during a rotation process, thereby stimulating activity of the catalyst and strengthening activation energy of the catalyst.

(3) In the disclosure, collision between the catalyst and the metal mesh can cause the organically contaminated soil on the metal mesh to fall off, thereby realizing regeneration of the metal mesh and ensuring a contact area between the catalyst and the organically contaminated soil.

(4) In the disclosure, by using a polygonal turbine structure, that is, the metal mesh with the ratchet shape, the contact area between the catalyst and the organically contaminated soil is increased. Meanwhile, during an operation process, the thermal desorption cylinder is rotated in the forward and reverse directions, so as to avoid accumulation of the organically contaminated in dead corners to further increase the contact area between the catalyst and the organically contaminated soil.

### BRIEF DESCRIPTION OF DRAWINGS

FIG. 1 illustrates a schematic structural diagram of a catalytic thermal desorption remediation device for organically contaminated soil according to an embodiment of the disclosure.

FIG. 2 illustrates a radial sectional view of a thermal desorption cylinder of the catalytic thermal desorption remediation device according to the embodiment of the disclosure.

### DESCRIPTION OF REFERENCE SIGNS

1: metal mesh; 2: catalyst; 3: heating structure; 4: thermal desorption cylinder; 5: process port; 6: vent hole; 7: exhaust pipe; 8: bearing; 9: bracket; 10: catalyst gate; 11: rotating motor; 12: soil inlet; 13: inlet gate; 14: reaction chamber.

### DETAILED DESCRIPTION OF EMBODIMENTS

In description of the disclosure, directional terms (up, down, left, right, front, back) are used to facilitate intuitive description of technical solutions of the disclosure, rather than indicating that the disclosure has a specific orientation structure and operation, and should not be construed as a limitation to the disclosure.

In the description of the disclosure, terms “first stage”, “second stage”, “primary”, and “secondary” are merely used for a purpose of distinguishing technical features and should not be understood as indicating a quantity of the technical features of the disclosure or specifying sequential relationship of the technical features of the disclosure.

In the disclosure, terms “dispose”, “install”, “connect” should be should be understood in a broad sense. They can be direct connection or indirect connection, fixed connection or detachable connection, or integral molding.

The disclosure will be described in detail with reference to attached drawings and embodiments. The embodiments are implemented based on the technical solutions of the disclosure, and detailed implementation and specific operation process are provided, but a scope of protection of the disclosure is not limited to the following embodiments.

In the following embodiments, unless otherwise indicated, functional components or structures are all components or structures used in related art to achieve corresponding functions.

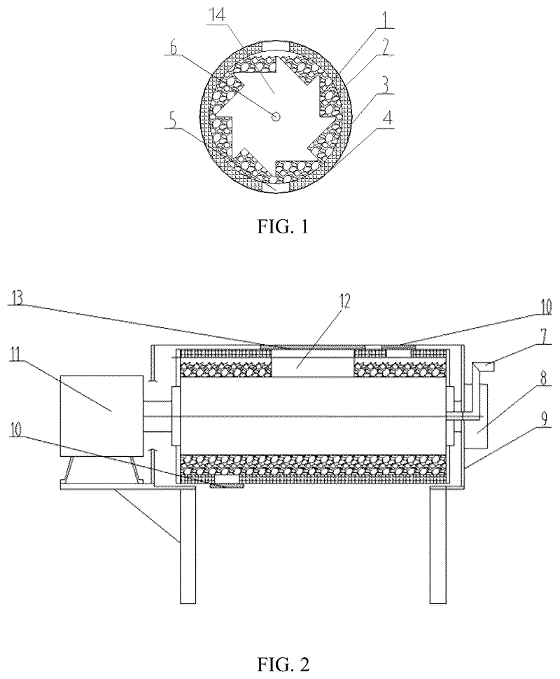

To realize efficient thermal desorption of organically contaminated soil to remove pollutants, a catalytic thermal desorption remediation device for organically contaminated soil is provided by the embodiment, as illustrated in FIG. 1, including: a thermal desorption cylinder 4, a heating structure 3, a metal mesh 1, catalyst 2, process ports 5, catalyst gates 10, a soil inlet 12, an inlet gate 13, a rotating motor 11, a bearing 8, a bracket 9, a vent hole 6 and an exhaust pipe 7. The thermal desorption cylinder 4 can rotate on its own axis. The thermal desorption cylinder 4 has a concentric structure. The heating structure 3 is disposed between outer concentric circles, and a heating temperature can be controlled by external wireless. The metal mesh 1 is disposed on an innermost side of the thermal desorption cylinder 4. The catalyst 2 is filled between the metal mesh 1 and an inner wall of the concentric circle. The process ports 5 are defined on a top and a bottom of the thermal desorption cylinder 4 to load and discharge the catalyst 2. The catalyst gates 10 are disposed at the process ports 5, and the catalyst gates10 are configured to close or open the process ports 5. The soil inlet 12 and the inlet gate 13 are disposed on a middle of the thermal desorption cylinder 4 in a length direction. An end of the thermal desorption cylinder 4 is connected to the rotating motor 11, and another end of the thermal desorption cylinder 4 is connected to the bearing 8. The rotating motor 11 and the bearing 8 are disposed on the bracket 9. The vent hole 6 is defined at a rotation center of the another end of the thermal desorption cylinder 4 connected to the bearing 8, and the vent hole 6 is rotatably sealed to the exhaust pipe 7.

The disclosure ensures catalytic performance of the catalyst by maintaining a use temperature of the catalyst and increasing activation energy of the catalyst. Through a combination of structure and use method, a contact area between the catalyst and the organically contaminated soil is ensured, and an objective of reducing a thermal desorption remediation temperature of organically contaminated soil is realized. Meanwhile, low-temperature remediation not only reduces energy consumption, but also ensures content of organic matter in soil and reduces an impact of remediation process on soil fertility.

In an embodiment, the metal mesh 1 has a polygonal ratchet structure as a whole, and equivalent diameters of meshes are slightly smaller than a median particle diameter (D50) of the catalyst 2. The metal mesh 1 is fixed to sidewalls at both ends of the thermal desorption cylinder 4. The metal mesh 1 is configured to ensure that the catalyst 2 will not enter remediation soil, and at the same time, presence of the catalyst 2 hinders entry of soil particles into the catalyst 2.

Requirements for the catalyst 2 are only related to its external shape. Specifically, the catalyst 2 is in a granular form, with a particle size ranging from 5 millimeters (mm) to 20 mm. A gap between the catalyst 2 and an inner wall of a filter housing is not less than 20 mm, and a filling rate of the catalyst 2 in the thermal desorption cylinder 4 is in a range of 70% to 90%. A particle size of catalyst particles is roughly the same as that of the soil particles. At contact interfaces between the catalyst particles and the soil particles, catalytic effect is better. Meanwhile, during a use process, the catalyst particles continue to collide with each other, to thereby stimulate activation performance of the catalyst 2 and strengthen the catalytic effect.

The heating temperature of the heating structure 3 ranges from the room temperature to 200 Celsius Degrees (° C.), and specific heating temperature is determined by the use temperature of the catalyst 2. The heating structure 3 is configured to maintain an optimal activation temperature of the catalyst 2 in real-time and ensure the catalytic performance of the catalyst 2. Specifically, the heating structure 3 is a heating sleeve disposed on an inner wall of the thermal desorption cylinder 4, and heating coils disposed inside the heating sleeve.

A rotating speed of the rotating motor 11 is in a range of 3 revolutions per minute (r/min) to 100 r/min. The rotating motor 11 can be set to rotate in forward and reverse directions according to actual needs. The rotating motor 11 is configured to strengthen thermal desorption and catalytic operation, purify contact surfaces between the catalyst 2 and the organically contaminated soil, and avoid occurrence of remediation dead corners.

A catalytic thermal desorption remediation method for the organically contaminated soil based on aforementioned catalytic thermal desorption remediation device, includes the following step (1) through step (8).

Step (1), a catalyst gate 10 on the top of the thermal desorption cylinder 4 is opened. The catalyst 2 is loaded into the catalytic thermal desorption remediation device through a process port 5 on the top of the thermal desorption cylinder 4. When a filling amount of the catalyst is met, the catalyst gate 10 on the top of the thermal desorption cylinder 4 is closed.

Step (2), the heating structure 3 is started. The heating temperature is controlled at a temperature suitable for the catalyst 2.

Step (3), the inlet gate 13 is opened. The organically contaminated soil is loaded into the catalytic thermal desorption remediation device through the soil inlet 12. The inlet gate 13 is closed.

Step (4), the rotating motor 11 is started. The rotating speed, reversal frequency and time of the rotating motor 11 are adjusted. During an operation process, the thermal desorption cylinder 4 rotates alternately in the forward and reverse directions.

Step (5), a gas generated inside the thermal desorption cylinder 4 is discharged through the vent hole 6 and the exhaust pipe 7 externally disposed.

Step (6), after a remediation process is completed, the rotating motor 11 is adjusted to rotate in a counterclockwise direction with the rotating speed being adjusted to a range of 10 r/min to 30 r/min for 0.5 minutes (min) to 2 min, then the rotating motor 11 is turned off. The soil inlet 12 is rotated to a lowest position, the inlet gate 13 on the soil inlet 12 is opened to discharge the remediated soil.

Step (7), the catalyst gate 10 on the top of the thermal desorption cylinder 4 is opened to supplement a certain amount of catalyst as needed.

Step (8), a catalyst gate 10 on the bottom of the thermal desorption cylinder 4 is opened according to the remediation requirements to discharge the existing catalyst 2. The catalyst gate 10 on the bottom of the thermal desorption cylinder 4 is closed to wait for new catalyst to be added again.

### Embodiment 1

To realize thermal desorption treatment for the organically contaminated soil, the embodiment adopts the aforementioned catalytic thermal desorption remediation device and method for organically contaminated soil to remediate organically contaminated soil in a polluted plot in Baoshan District, Shanghai, which contains about 800 milligrams per kilogram (mg/kg) of o-xylene. The remediation reaches below a screening value for second-class land.

The thermal desorption cylinder 4 has a diameter of about 1.5 meters (m), and a length of 3 m.

According to types and remediation requirements of soil pollutants, cerium-manganese supported on alpha-phase ferric oxide (Ce—Mn/α-Fe₂O₃) catalyst (method for preparing the Ce—Mn/α-Fe₂O₃ catalyst refers to embodiment 1 of a Chinese patent publication No. CN117797828A) is used. The catalyst is produced into uniform particles with an equivalent diameter of about 8 mm, and a total amount of the catalyst used accounts for about 3% of a total mass of the organically contaminated soil to be remediated.

A radial section of the metal mesh 1 is in a ratchet shape, and the meshes are in circular shape with diameters of about 6 mm. The metal mesh 1 is fixed to the sidewalls at the both ends of the thermal desorption cylinder 4.

Before use, the catalyst is firstly added into an interlayer between the metal mesh 1 and the heating structure 3, and the filling rate of the catalyst is about 85%. The heating structure 3 is started to preheat to 60° C.

Specific use method of the catalytic thermal desorption remediation device includes the following step (1) through step (8).

Step (1), the catalyst gate 10 on the top of the thermal desorption cylinder 4 is opened. The Ce—Mn/α-Fe₂O₃ catalyst is loaded into the interlayer between the metal mesh 1 and the heating structure 3 inside the catalytic thermal desorption remediation device through the process port 5 on the top of the thermal desorption cylinder 4. When the filling amount of the Ce—Mn/α-Fe₂O₃ catalyst reaches 85%, the catalyst gate 10 on the top of the thermal desorption cylinder 4 is closed.

Step (2), the heating structure 3 is started. The heating temperature is controlled to 120° C. and maintained to 120° C.

Step (3), the inlet gate 13 is opened. The organically contaminated soil is loaded into the catalytic thermal desorption remediation device through the soil inlet 12. When a filling rate of the organically contaminated soil reaches about 65%, the inlet gate 13 is closed.

Step (4), the rotating motor 11 is started. A working procedure of the rotating motor 11 is: rotating in a clockwise direction with the rotating speed of 5 r/min for 2 min, then rotating in the counterclockwise direction with the rotating speed of 10 r/min for 1 min, and continuing to rotate alternately in the clockwise direction and the counterclockwise direction.

Step (5), the gas generated inside the thermal desorption cylinder 4 is discharged through the vent hole 6 and the exhaust pipe 7 externally disposed.

Step (6), after the remediation process is completed, the rotating motor 11 is adjusted to rotate in the counterclockwise direction with the rotating speed being adjusted to 30 r/min for 2 min until the soil inlet 12 is rotated to the lowest position. The rotating motor 11 is turned off. The inlet gate 13 is opened to discharge the remediated soil.

Step (7), the catalyst gate 10 on the top of the thermal desorption cylinder 4 is opened. After an inspection, the catalyst is found not necessary to be supplemented, and then the organically contaminated soil is continually loaded into the catalytic thermal desorption remediation device and step (2) through step (6) are repeated.

Step (8), finally, after the remediation process is completed, the catalyst gate 10 on the bottom of the thermal desorption cylinder 4 is opened to discharge the catalyst. The catalyst gate 10 on the bottom of the thermal desorption cylinder 4 is closed to wait for new catalyst to be added again.

A third-party test results shows that a concentration of the o-xylene in the remediated soil is 283 mg/kg, meeting requirements of second-class land use.

Aforementioned description of the embodiments is intended to facilitate understanding and use of the disclosure by those skilled in the art. Apparently, those skilled in the art can easily make modifications to the embodiments, and apply general principles explained in the specification to other embodiments without creative labors. Therefore, the disclosure is not limited to aforementioned embodiments. Based on revelation of the disclosure, all improvements and modifications made by those skilled in the art without departing from a scope of the disclosure shall fall with the scope of protection of the disclosure.

What is claimed is:

1. A catalytic thermal desorption remediation device for organically contaminated soil, comprising:
a thermal desorption cylinder (4), rotatably disposed, wherein a metal mesh (1) is annularly disposed inside the thermal desorption cylinder (4) to define a reaction chamber (14), and the reaction chamber (14) is configured to contain the organically contaminated soil;
a heating structure (3), disposed on an inner wall of the thermal desorption cylinder (4); and
catalyst (2), filled between the heating structure (3) and the metal mesh (1), wherein a stacking volume of the catalyst (2) is in a range of 75% to 95% of a volume between the heating structure (3) and the metal mesh (1).

2. The catalytic thermal desorption remediation device for the organically contaminated soil as claimed in claim 1, wherein process ports (5) are thoroughly defined on a sidewall of the thermal desorption cylinder (4) and the heating structure (3), and the process ports (5) are configured to load the catalyst (2).

3. The catalytic thermal desorption remediation device for the organically contaminated soil as claimed in claim 2, wherein catalyst gates (10) are disposed at the process ports (5), and the catalyst gates (10) are configured to close or open the process ports (5).

4. The catalytic thermal desorption remediation device for the organically contaminated soil as claimed in claim 1, wherein a soil inlet (12) is thoroughly defined on the sidewall of the thermal desorption cylinder (4) and the heating structure (3), and the soil inlet (12) is configured to load the organically contaminated soil into the reaction chamber (14).

5. The catalytic thermal desorption remediation device for the organically contaminated soil as claimed in claim 4, wherein an inlet gate (13) is disposed on the soil inlet (12).

6. The catalytic thermal desorption remediation device for the organically contaminated soil as claimed in claim 1, wherein the metal mesh (1) is disposed inside the thermal desorption cylinder (4) in a cylindrical shape.

7. The catalytic thermal desorption remediation device for the organically contaminated soil as claimed in claim 6, wherein a radial section of the metal mesh (1) is in a ratchet shape.

8. The catalytic thermal desorption remediation device for the organically contaminated soil as claimed in claim 1, further comprising a rotating motor (11) configured to drive the thermal desorption cylinder (4) to rotate.

9. The catalytic thermal desorption remediation device for the organically contaminated soil as claimed in claim 1, further comprising a bracket (9), a bearing (8) disposed on the bracket (9) and an exhaust pipe (7) disposed on the bracket (9);
wherein the thermal desorption cylinder (4) is rotatably disposed on the bracket (9) through the bearing (8); and
wherein a vent hole (6) is defined at a rotation center of an end surface of the thermal desorption cylinder (4), and the exhaust pipe (7) extends to the vent hole (6) and is rotatably sealed to the vent hole (6).

10. A catalytic thermal desorption remediation method for the organically contaminated soil based on the catalytic thermal desorption remediation device as claimed in claim 9, comprising the following steps:
S1, starting the heating structure (3), and controlling a temperature of the heating structure (3) at a reaction temperature;
S2, loading the organically contaminated soil into the reaction chamber (14), and then sealing the reaction chamber (14); and
S3, alternately rotating the thermal desorption cylinder (4) in forward and reverse directions to promote reaction to remove organic pollutants from the organically contaminated soil to thereby obtain processed soil; and discharging a reaction gas generated in the reaction chamber (14) through the vent hole (6).
